(19) United States
(12) Patent Application Publication
(10) Pub. No.: US 2006/0095398 A1
(43) Pub. Date: May 4, 2006

(54) Automatic defocussing of displayed multimedia information on client by monitoring static and dynamic properties of the client

(76) Inventor: Vasudev Bhaskaran, Sunnyvale, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/981,355

(22) Filed: Nov. 4, 2004

(51) Int. Cl. G06F 17/30

(52) U.S. Cl. 707/1

(57) ABSTRACT

Automatic defocusing of displayed multimedia information (e.g., video) on a client in a client-server system by monitoring dynamic display properties of the client provides more efficient use of resources in the system. In one embodiment, bandwidth is conserved by configuring the server with the capability of defocus select data being sent to the client based on the client's dynamic display properties. The defocused data can be sent at a lower bit-rate. In another embodiment, the client's decoder is configured to receive and process the monitoring information and make adjustments on the client side. In this situation, only viewable data is decoded accurately; other, obstructed data can be decoded at a lower accuracy.

### BACKGROUND OF THE INVENTION

1. Field of the Invention

The present invention relates to techniques that enable more efficient use of resources with regard to multimedia information transmitted between a server and a client based on the client's monitored display conditions. The techniques may be realized as a method, various steps/aspects of which may be performed by an appropriately configured device or apparatus, with the functions being embodied in the form of software, hardware, or combination thereof.

2. Description of the Related Art

In conventional multimedia communication systems involving a server and one or more clients, the server simply sends all of the information to a particular client, and the client may decode all of the information (video, audio, etc.). Frequently, however, not all of the client's display is available for viewing the video, since the client has one or more other applications open and running. In that case, the client's display engine displays only a portion of the decoded video frames, i.e., that portion that is not obstructed by the window(s) of the other application(s) running.

This approach is wasteful for several reasons. From a communications standpoint, bandwidth is wasted since the server is sending information that is ultimately not seen by the user at the client. Secondly, computing resources are unnecessarily expended, since the client still decodes all of the video frames even though some of the content of those frames are not viewable. Thirdly, from a display viewpoint, excessive information may be created if the client is not able to display, say, the full color depth or the full frame rate of the video. These inefficiencies are further exacerbated in a situation in which (i) the client is focusing, not on the video, but on one of the other applications that is open and running, and/or (ii) the communications, computing, and/or display resources are limited.

One way of addressing this problem is to adapt the multimedia information based on the client's static properties, i.e., the network connectivity speed, the display resolution, and/or the video refresh rate. While this technique is able to decrease the inefficiencies noted above, further improvements are desirable, particularly when the client's resources are limited.

### OBJECTS OF THE INVENTION

Accordingly, it is an object of the present invention to provide techniques for further improving the resource-use efficiency of client-server systems.

Another object of this invention is to provide techniques for automatically defocusing select multimedia information displayed on a client by monitoring dynamic properties of the client.

### SUMMARY OF THE INVENTION

According to one aspect of the invention, a method for controlling the sending of multimedia data (preferably including video data) from a server to a client based on the client's display conditions is provided. The method comprises monitoring one or more dynamic display properties of the client; and automatically defocusing at least a portion of the multimedia data to be sent to the client based on the dynamic display property or properties of the client being monitored, while maintaining a state of streaming of the defocused portion.

In another aspect, the invention involves a method for adapting the decoding of multimedia data (preferably including video data) in a client based on the client's display conditions. The method comprises monitoring one or more dynamic display properties of the client; and automatically defocusing at least a portion of the multimedia data to be rendered on the client based on the dynamic display property or properties of the client being monitored, while maintaining a state of streaming of the defocused portion.

The dynamic display property or properties of the client includes which of a plurality of windows being displayed on the client is in the foreground and which is in the background, which portion or of each window being displayed is obscured by another window, and/or whether a window being displayed on the client has been resized or moved.

Preferably, the monitoring step comprises determining what portion of the multimedia data is currently not needed by the client. Moreover, in the server-side defocusing method, the monitoring step may be carried out using band signaling between the client and the server or using a backchannel communication between the client and the server.

Preferably, in server-side defocusing, the automatically defocusing step comprises sending the portion of the multimedia data that is currently not needed by the client at a lower bandwidth than other multimedia data being sent to the client. In client-side defocusing, the automatically defocusing step preferably comprises adjusting an inverse transform or dequantization operation to decode the portion of the multimedia data that is currently not needed by the client more coarsely than other multimedia data to be rendered on the client.

Preferably, the state of streaming of the defocused portion of the multimedia data is maintained during the automatically defocusing step such that, when the client takes action to indicate a need for the defocused portion, the current data of the defocused portion is rendered on the client.

Still another aspect of the invention is a client-server system that is configured to perform the functions of either or both of the methods described-above.

According to other aspects of the invention, any of the above-described methods or steps thereof may be specified by program instructions, e.g., software, that are embodied on a device-readable medium that is conveyed to, or incorporated in, an instruction-based, processor-controlled device. In the case of server-side defocusing, the program of instructions module may be embodied directly in the server. When the client performs the defocusing, the program of instructions module may be embodied in the client's codec or decoder. The program instructions are not limited to software form. Alternatively, instructions may be specified directly by a hardware configuration, e.g., an application specific integrated circuit (ASIC), digital signal processing circuitry, etc.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings like reference symbols refer to like parts.

FIG. 1 is a schematic illustration of a videoconferencing system in accordance with embodiments of the present invention.

FIG. 2 is a block diagram showing the data flow of an examplary video conferencing system in which a codec (encoder/decoder) is installed at each site.

FIGS. 3(a) and (b) are functional block diagrams of encoder and decoder portions respectively of a codec configured in accordance with embodiments of the invention

FIG. 4 is a flow chart illustrating processes of automatically defocusing select data being sent to, or decoded by, a client based on its static and dynamic properties, according to embodiments of the invention.

FIG. 5 shows an exemplary arrangement of windows on a client for purposes of illustrating aspects of the present invention.

### DESCRIPTION OF THE PREFERRED EMBODIMENTS

The present invention significantly improves the resource-use efficiency of client-server systems by monitoring and thereby becoming aware of the dynamic properties of the client's display conditions. This may be done in conjunction with monitoring the client's static properties. In one embodiment, the server is configured with the capability of modulating the sending of multimedia information (e.g., video) based on such display conditions. That portion of the video frame(s) that is obstructed by one or more other windows on the client's display or otherwise not viewable can be sent at a lower bandwidth. Only the viewable or otherwise useable portion of the video stream need be sent at the appropriate resolution. In another embodiment, the adjustments are made on the client side, e.g., by the client's decoder, which is aware of the client's dynamic display conditions and adapts the decoding of the video accordingly. For example, only the viewable, e.g., unobstructed, portion of the video need be decoded accurately. The rest can be decoded at a lower accuracy, thus decreasing the number of computing cycles that would otherwise be required if the entire video was so decoded. Thus, from a bandwidth or a client computing resources viewpoint, a client-server system using the present invention requires fewer resources.

In a typical videoconference setting, a client may be simultaneously running multiple applications but is typically focusing on only one such application at a time. Detecting that information, certain multimedia information that the client currently does not need can be automatically defocused. For example, the client may be running a spreadsheet program and at some point bring the spreadsheet to the foreground and the video to the background. In accordance with one embodiment of this invention, the server then adopts a strategy in which the video is defocused and only the audio of that media stream is sent, but the state of the streaming is still maintained at the server so that when the client indicates a need for the video, i.e., by moving the video to the foreground, the server immediately skips to the current frame. In accordance with another embodiment, the defocusing is accomplished by the decoder, which does not decode, or only coarsely decodes, the portion of the video not needed.

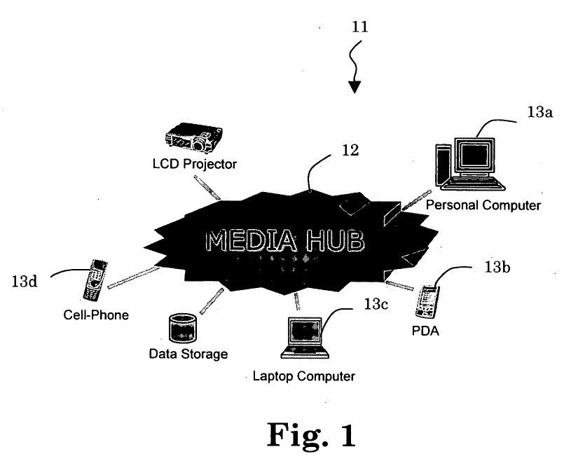

FIG. 1 schematically illustrates a videoconference system 11, of the type contemplated by the invention. System 11 comprises a server 12 and a plurality of client devices 13. Server 12 may be of the type that is used in a typical videoconference system. In one embodiment, the server functions as a media hub to provide seamless communication between different client devices in an integrated media exchange (IMX) system, e.g., a large-scale videoconference system. The client devices 13 with which the server is in communication may be of any of a variety of types: personal computer 13a, personal digital assistant (PDA) 13b, laptop 13c, cell phone 13d, etc. The number and type of client devices 13 in system 11 will, of course, vary depending on the needs being serviced by system 11 and the system's available resources. The invention is primarily designed for those client devices having video viewing capability.

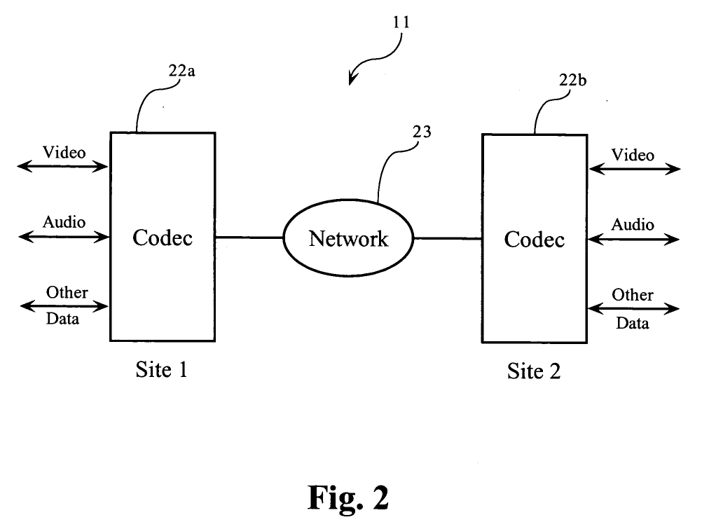

The primary component of videoconferencing system 11 is a codec (encoder/decoder device) 22, which is shown, along with the system data flow, in FIG. 2. The illustrated arrangement includes two sites, but may include more as discussed above. A codec 22a/22b is installed at each site. In a server-based system, such an arrangement enables each client device to send content to, and receive content from, any of the other client devices in the system through via a network 23 and the server. In the event that a particular client device does not contain a codec, communication with the server is still possible, but the server must be able to communicate with such client in a manner that is compatible with that client's capabilities.

Other devices may be provided at a particular videoconferencing site, depending on the particular environment that the system is supporting. For example, if the system is to accommodate a live videoconference, each site may also include (if not already included in the client device) appropriate devices to enable the participant at that site to see and communicate with the other participants. Such other devices (not shown) may include camera(s), microphone(s), monitor(s), and speaker(s).

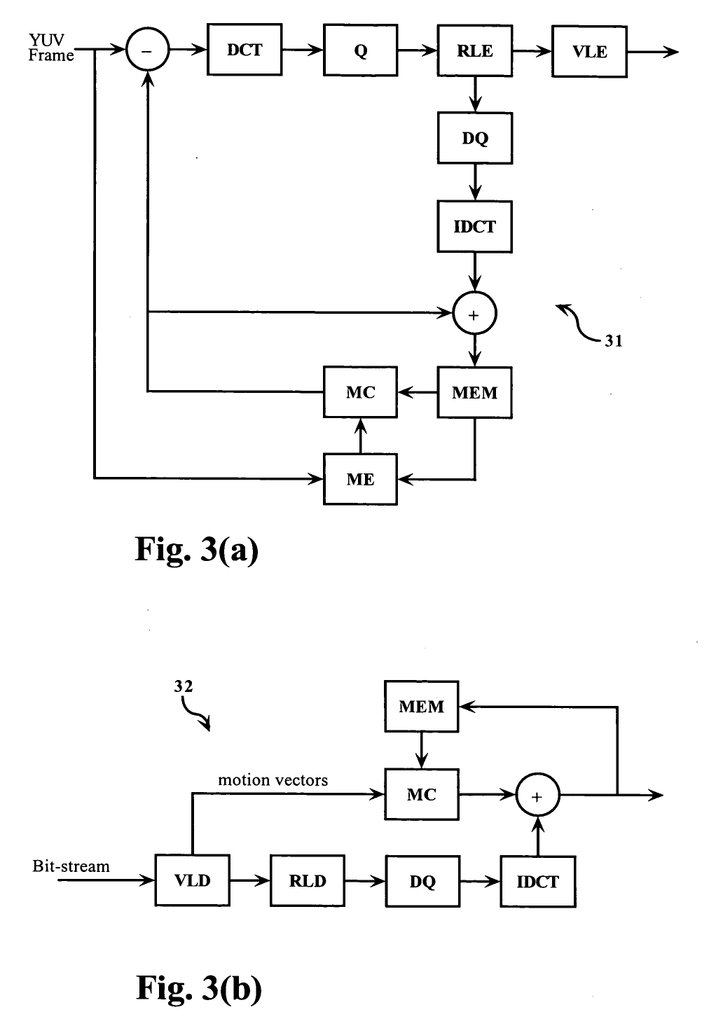

A codec 22, according to embodiments of the invention, includes both an encoder 31 as shown in FIG. 3(a) and a decoder 32 as shown in FIG. 3(b). The encoder 31 digitizes and compresses the incoming signals, multiplexes those signals, and delivers the combined signal (e.g., a baseband digital signal) to a network for transmission to other codecs in the system. The decoder 32 accepts a similarly encoded signal from the network, demultiplexes the received signal, decompresses the video and audio, and provides analog video and audio outputs. A typical codec has a several techniques that may be employed in digitizing and compressing video and audio, including picture resolution reduction, color information transformation and sub-sampling, frame rate control, intra- and inter-frame coding, and entropy coding. In some applications, e.g., business group videoconferencing systems, the codec will typically contain more functions, in addition to video, audio and network functions. Such codecs accept and multiplex data from graphics devices and computers. These codecs may also accept inputs from control panels and hand-held remotes.

As shown in FIG. 3(a), with respect to video data, encoder 31 receives a current video frame represented by a block of pixels (which may be in YUV color space). That frame is sent to a motion estimation (ME) module where a motion vector is generated and to an operator where a best-matching block of the previous frame and a block to be coded in the current frame are differenced to predict the block in the current frame and to generate a prediction error. The prediction error, along with the motion vector, is transmitted to a Discrete Cosine Transform (DCT) module where the data is transformed into blocks of DCT coefficients. These coefficients are quantized in a Quantization (Q) module. A Run Length Encoder (RLE) and a Variable Length Encoder (VLC) encode the data for transmission.

The motion compensation loop branches off from the Q module. The quantized coefficients of the prediction error and motion vector and dequantized in a DeQuantization (DQ) module and subjected to an inverse DCT operation in a IDCT module. That result is combined with the motion compensated version of the previous frame and stored in a single frame buffer memory (MEM). The motion vector is generated from the result stored in MEM and the current unprocessed frame in a Motion Estimation (ME) module. The motion vector is provided to a Motion Compensation (MC) module where the best-matching block of the previous frame is generated.

The decoder 32 essentially reverses the operations of the encoder 31. As shown in FIG. 3(b) the decoder 32 receives a bit-stream (preferably H.263 compliant) to which variable length and run length decoding operations are applied in VLD and RLD modules, respectively. The resulting data is dequantized in a DQ module and that result subjected to an IDCT operation to recover a pixel representation. The VLD module also generates a motion vector for the current frame and that vector is supplied to a MC module, which takes that and the previous frame in memory (MEM) and generates a motion compensation vector. That motion compensated vector is summed with the recovered pixel representation from the IDCT module to yield a current frame.

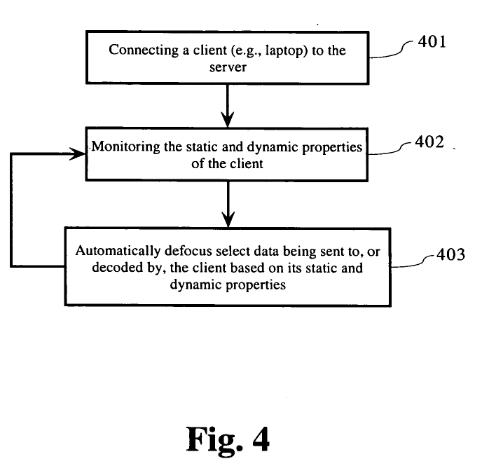

Having described the components and environments in which the invention may be practiced, methods by which more efficient use of system resources can be realized will now be discussed. FIG. 4 is a flow chart generally illustrating such methods. After a connection is made between server 12 and a client 13, e.g., laptop 13c (step 401), the static and dynamic properties of client 13 are monitored (step 402). In one embodiment, it is the server 12 that does the monitoring. In another embodiment, the decoder in the client 13 monitors its own static and dynamic properties.

The static properties that may be monitored include the network connectivity speed, the laptop's display resolution, and/or the laptop's video refresh rate. In a typical videoconference setting, the user of client 13 may be running other applications displayed in windows on the screen while receiving the video stream in another window. Thus, this invention advantageously monitors dynamic properties of the client's display conditions, which preferably include tracking the user's actions with respect to windows on the client's display.

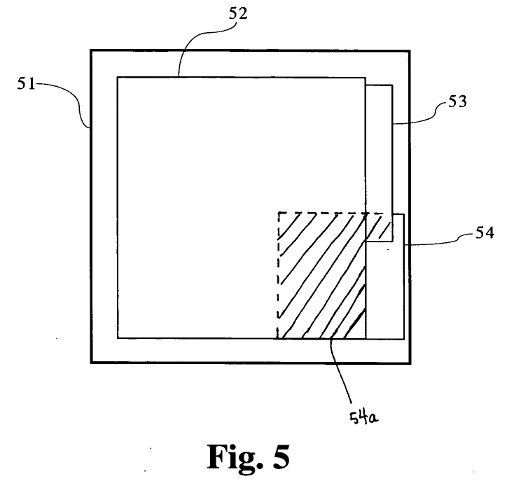

Of those windows being displayed by client 13, server 12 or the client's decoder detects which are in the foreground and which are in the background, which is indicative of the relative priority of the information being rendered on the laptop's display. An exemplary arrangement of windows on client 13 is shown in FIG. 5. The client's display screen 51 has three windows open. In the illustrated arrangement, window 52, which represents a local program (e.g., spreadsheet, word processing, etc.) opening and running on the client 13, is in the foreground and therefore of most concern to the user at the present time. Window 53, which is partially obscured by window 52, may be another local application such as e-mail that is of somewhat lesser importance at this time. Window 54 is a video that the client is receiving from server 12 but obviously not being watching closely by the user at this time. Window 54 is in the background, being partially obscured by both windows 52 and 53.

The overlapping nature of the windows arrangement on the client's screen, that is, which portion of each window being displayed is completely obscured by another window or portion thereof, can also be detected. The relative importance of a window is generally commensurate with how little it is obscured. Any window that is partially obscured is deemed relatively unimportant (in proportion to the percentage that is obscured), and data in completely obscured windows or portions thereof is deemed not needed by the client 13.

Select data is then automatically defocused (step 403). In one embodiment, server 12 then automatically defocuses select data being sent to client 13. In another embodiment, the client's decoder defocuses select data as it is being decoded. In either embodiment, the select data that is defocused could be all data in a background window, all data in a background window that has a certain percentage of its viewable area obscured, or it could be just the data in that portion of a window that is obscured. Thus, in the illustrated example of FIG. 5, all of the video data could be defocused or just that portion of the data in the obscured area 54a of window 54. The defocusing by server 12 is accomplished by sending the select data at a lower bandwidth. The defocusing by the client's decoder is accomplished in one embodiment by adjusting an inverse transform or dequantization operation to decode the select data more coarsely than other multimedia data to be rendered on the laptop's display.

The monitoring of the static and dynamic properties of client 13, e.g., laptop 13c and the resulting defocusing of select data being sent to, or decoded by, the client 13 continues during network session. That is, the data that is defocused changes in real-time as the monitoring reveals changed circumstances on the client 13.

As the foregoing demonstrates, the present invention provides techniques for automatic defocusing of displayed multimedia information on a client by monitoring dynamic properties of the client. As will be appreciated from the above description, the invention is generally applicable to any client-server system, but is particularly applicable in situations in which the client has a limited size display, limited computing resources, and/or is connected to the server or other communications device over a relatively narrow bandwidth link. Thus, the invention has particular application in a communication system in which a mobile device (e.g., cell phone, PDA, etc.) has one or more applications open and running, while also receiving a video feed. In this environment, one embodiment of the invention provides the server with the capability to monitor both the static and dynamic properties of the mobile device and to modulate the sending of video data thereto based on the detected properties, and to thereby conserve bandwidth. In another embodiment, the client selectively decodes only the video data needed by or viewable on the client, thereby saving computing cycles.

While the invention has been described in conjunction with several specific embodiments, it is evident to those skilled in the art that many further alternatives, modifications and variations will be apparent in light of the foregoing description. Thus, the invention described herein is intended to embrace all such alternatives, modifications, applications and variations as may fall within the spirit and scope of the appended claims.

What is claimed is:

1. A method for controlling the sending of multimedia data from a server to a client based on the client's display conditions, comprising:
monitoring at least one dynamic display property of the client; and
automatically defocusing at least a portion of the multimedia data to be sent to the client based on the at least one dynamic display property of the client being monitored, while maintaining a state of streaming of the defocused portion.

2. A method as recited in claim 1, wherein the at least one dynamic display property of the client includes:
which of a plurality of windows being displayed on the client is in the foreground and which is in the background,
which portion or of each window being displayed is obscured by another window, or
whether a window being displayed on the client has been resized or moved.

3. A method as recited in claim 2, wherein the monitoring step comprises determining what portion of the multimedia data is currently not needed by the client.

4. A method as recited in claim 3, wherein the monitoring step is carried out using band signaling between the client and the server or using a backchannel communication between the client and the server.

5. A method as recited in claim 3, wherein the automatically defocusing step comprises sending the portion of the multimedia data that is currently not needed by the client at a lower bandwidth than other multimedia data being sent to the client.

6. A method as recited in claim 3, wherein the state of streaming of the defocused portion of the multimedia data being sent to the client is maintained during the automatically defocusing step such that, when the client takes action to indicate a need for the defocused portion, the current data of the defocused portion is rendered on the client.

7. A method as recited in claim 3, wherein the multimedia data includes video data.

8. A method for adapting the decoding of multimedia data in a client based on the client's display conditions, comprising:
monitoring at least one dynamic display property of the client; and
automatically defocusing at least a portion of the multimedia data to be rendered on the client based on the at least one dynamic display property of the client being monitored, while maintaining a state of streaming of the defocused portion.

9. A method as recited in claim 8, wherein the at least one dynamic display property of the client includes:
which of a plurality of windows being displayed on the client is in the foreground and which is in the background,
which portion or of each window being displayed is obscured by another window, or
whether a window being displayed on the client has been resized or moved.

10. A method as recited in claim 9, wherein the monitoring step comprises determining what portion of the multimedia data is currently not needed by the client.

11. A method as recited in claim 10, wherein the automatically defocusing step comprises adjusting an inverse transform or dequantization operation to decode the portion of the multimedia data that is currently not needed by the client more coarsely than other multimedia data to be rendered on the client.

12. A method as recited in claim 10, wherein the state of streaming of the defocused portion of the multimedia data is maintained during the automatically defocusing step such that, when the client takes action to indicate a need for the defocused portion, the current data of the defocused portion is rendered on the client.

13. A method as recited in claim 10, wherein the multimedia data includes video data.

14. A module for controlling the sending of multimedia data from a server to a client based on the client's display conditions, the module comprising one or more components configured to:
monitor at least one dynamic display property of the client; and
automatically defocus at least a portion of the multimedia data to be sent to the client based on the at least one dynamic display property of the client being monitored, while maintaining a state of streaming of the defocused portion.

15. A module as recited in claim 14, wherein the module is a program of instructions is embodied on a device readable medium, the program of instructions being implemented by software, hardware, or combination thereof.

16. A module as recited in claim 14, wherein the module is incorporated in an encoder of the server.

17. A module for adapting the decoding of multimedia data in a client based on the client's display conditions, the module comprising one or more components configured to:
monitor at least one dynamic display property of the client; and
automatically defocus at least a portion of the multimedia data to be rendered on the client based on the at least one dynamic display property of the client being monitored, while maintaining a state of streaming of the defocused portion.

18. A module as recited in claim 17, wherein the module is a program of instructions is embodied on a device readable medium, the program of instructions being implemented by software, hardware, or combination thereof.

19. A module as recited in claim 17, wherein the module is incorporated in a decoder of the client.

20. A client-server system, comprising:
a module for (i) controlling the sending of multimedia data from a server to a client based on the client's display conditions, or (ii) adapting the decoding of multimedia data in a client based on the client's display conditions, the module comprising one or more components configured to:
monitor at least one dynamic display property of the client; and
automatically defocus at least a portion of the multimedia data to be (i) sent to, or (ii) rendered on, the client based on the at least one dynamic display property of the client being monitored, while maintaining a state of streaming of the defocused portion.
